(19) United States
(12) Patent Application Publication
(10) Pub. No.: US 2026/0323527 A1
(43) Pub. Date: Oct. 15, 2026

(54) USER EQUIPMENT, NETWORK NODE AND METHODS PERFORMED THEREIN FOR UPLINK TRANSMISSION(S)

(71) Applicant: Telefonaktiebolaget LM Ericsson (publ), Stockholm (SE)

(72) Inventors: Chunhui ZHANG, STOCKHOLM (SE); Christian BERGLJUNG, LUND (SE); Muhammad Ali KAZMI, Reston, VA (US); Ling SU, BEIJING, Hebei (CN); Robert Mark HARRISON, GRAPEVINE, TX (US)

(21) Appl. No.: 19/484,815

(22) PCT Filed: May 14, 2024
(86) PCT No.: PCT/EP2024/063220

§ 371 Date: Nov. 14, 2025

Related U.S. Application Data
(60) Provisional application No. 63/466,535, filed on May 15, 2023.

(51) Int. Cl. H04W 52/14; H04W 52/34

(52) U.S. Cl. CPC H04W 52/146; H04W 52/34

(57) ABSTRACT

A method of a user equipment, UE, for performing an uplink, UL, transmission, a method of a network node for scheduling an UL transmission, a user equipment and a network node are disclosed. The method of UE for performing UL transmission comprises: determining an uplink, UL, duty cycle of the UL transmission including an unscheduled transmission; applying a power backoff setting to a transmission power for the UL transmission in response to the UL duty cycle being larger than capability information reported by the UE for compliance with electromagnetic power density exposure requirements, to determine an actual transmission power for performing the UL transmission; and transmitting the UL transmission using the actual transmission power.

### TECHNICAL FIELD

The present disclosure relates to wireless communications, and in particular, to a user equipment and a network node in a communication network and to methods performed in the user equipment for performing uplink, UL, transmission(s) and methods performed in the network node for scheduling uplink, UL, transmission(s).

### BACKGROUND

RACH repetition was introduced in Rel-13 WIs of “Further LTE Physical Layer Enhancements for MTC” and “NarrowBand IOT (NB-IOT)” to extend coverage.

RACH Repetition LTE eMTC, NB-IOT

Repetition of information is a technique used to achieve coverage enhancements. It is used for all physical channels available for coverage-enhanced UEs, i.e., M-PDCCH, PBCH, PDSCH, PUCCH, PUSCH and PRACH.

The UE decides the repetition level for the initial PRACH transmission. The repetition levels that the cell supports (e.g., 5, 10, and 15 dB) are included in the system information and the UE selects one of these based on, e.g., the estimated channel quality.

During initial random access:
UE measures the DL quality;
UE selects a suitable repetition level from among 4 levels for its initial PRACH preamble transmission;
If the UE does not receive a random access response (RAR), it increases its PRACH repetition level; and
Numbers of repetitions for RAR and following messages will depend on the level for the successful PRACH.

Coverage enhancement for the physical random access PRACH preamble can be achieved partly through relaxation of the required PRACH misdetection probability and partly through repetition of the legacy PRACH formats (e.g., repetition of the PRACH). A maximum of three different repetition levels (plus coverage enhancement level zero) can be configured, where each level has its own configurable number of repetitions and attempts in order to adapt to the UE's coverage situation. For initial random access, the UE chooses its repetition level based on RSRP measurements. If the UE does not receive a RAR after the maximum number of attempts of its current level, it moves to the next higher one. No power ramping is used for large repetition levels; the current procedure is otherwise used. Different coverage levels correspond to different PRACH resources (e.g., different combinations of preamble sequences, timing, and narrowbands) and the available resources are signaled in SIB.

The RAR message is scheduled with M-PDCCH and an associated PDSCH. The UE knows the repetition level, possible start subframe and frequency resource of the M-PDCCH from its most recent PRACH transmission (in combination with information signaled in SIB).

To enable different operation modes depending on a UE's need of coverage extension, two coverage enhancement modes have been introduced for RRC_CONNECTED UEs:
CE mode A for no or small coverage enhancement, requiring a few (e.g., up to a few tens of) repetitions.
CE mode B for a medium to large coverage enhancement, requiring several (e.g., hundreds of) repetitions.
   The network signals the CE mode to the UE.

Coverage enhancement modes: As mentioned earlier, the UE moves from no or small coverage enhancements (CE mode A) to large coverage enhancements (CE mode B) when signaled. The idea is to only keep a UE in CE mode B if it is not able to do synchronization acquisition, system information acquisition, random access or data transmission using small coverage operation. In enhanced coverage operation, the number of repetitions can be adapted according to the UE's coverage situation.

In 3GPP Specification 36.321 v17.2.0:
If the UE is a BL UE or a UE in enhanced coverage:
   if the random access preamble was transmitted in a non-terrestrial network:
      RA Response window starts at the subframe that contains the end of the last preamble repetition plus 3+UE-eNB RTT subframes, as specified in TS 36.213 [6] clause X.X and has length ra-ResponseWindowSize for the corresponding enhanced coverage level;
   else:
      RA Response window starts at the subframe that contains the end of the last preamble repetition plus three subframes and has length ra-Response Window Size for the corresponding enhanced coverage level.
If the UE is an NB-IoT UE:
   if the random access preamble was transmitted in a non-terrestrial network:
      RA Response window starts at the subframe that contains the end of the last preamble repetition plus X+UE-eNB RTT subframes, as specified in TS 36.213 [6] clause X.X and has length ra-ResponseWindowSize for the corresponding enhanced coverage level, where value X is determined from Table 5.1.4-1 based on the used preamble format and the number of NPRACH repetitions;
   else:
      RA Response window starts at the subframe that contains the end of the last preamble repetition plus X subframes and has length ra-ResponseWindowSize for the corresponding enhanced coverage level, where value X is determined from Table 5.1.4-1 based on the used preamble format and the number of NPRACH repetitions.

The RA-RNTI associated with the PRACH in which the Random Access Preamble is transmitted is computed as:

RA-RNTI=1+t_id+10*f_id

where t_id is the index of the first subframe of the specified PRACH (0≤t_id<10), and f_id is the index of the specified PRACH within that subframe, in ascending order of frequency domain (0≤f_id<6) except for NB-IoT UEs, BL UEs, or UEs in enhanced coverage. If the PRACH resource is on a TDD carrier, the f_id is set to f_{RA}, where f_{RA} is defined in clause 5.7.1 of TS 36.211 [7].

For BL UEs and UEs in enhanced coverage, RA-RNTI associated with the PRACH in which the Random Access Preamble is transmitted, is computed as:

RA-RNTI=1+t_id+10*f_id+60*(SFN_id mod(Wmax/10))

where t_id is the index of the first subframe of the specified PRACH (0≤t_id<10), f_id is the index of the specified PRACH within that subframe, in ascending order of frequency domain (0≤f_id<6), SFN_id is the index of the first radio frame of the specified PRACH, and Wmax is 400, maximum possible RAR window size in subframes for BL UEs or UEs in enhanced coverage. If the PRACH resource is on a TDD carrier, the f_id is set to f_{RA}, where f_{RA} is defined in clause 5.7.1 of TS 36.211.

For NB-IoT UEs, the RA-RNTI associated with the PRACH in which the Random Access Preamble is transmitted is computed as:

RA-RNTI=1+floor(SFN_id/4)+256*carrier_id

where SFN_id is the index of the first radio frame of the specified PRACH and carrier_id is the index of the UL carrier associated with the specified PRACH. The carrier_id of the anchor carrier is 0.

For BL/CE UEs, for each PRACH coverage enhancement level, there is a PRACH configuration configured by higher layers with a PRACH configuration index (prach-ConfigurationIndex), a PRACH frequency offset

$${\overline{n}}_{PRBoffset}^{RA}$$

(prach-FrequencyOffset), a number of PRACH repetitions per attempt

$${N}_{rep}^{PRACH}$$

(numRepetitionPerPreambleAttempt) and optionally a PRACH starting subframe periodicity

$${N}_{start}^{PRACH}$$

(prach-StartingSubframe). PRACH of preamble format 0-3 is transmitted

$${N}_{rep}^{PRACH} \geq 1$$

times, whereas PRACH of preamble format 4 is transmitted one time only.

For BL/CE UEs and for each PRACH coverage enhancement level, if frequency hopping is enabled for a PRACH configuration by the higher-layer parameter prach-HoppingConfig, the value of the parameter

$${n}_{PRB offset}^{RA}$$

depends on the SFN, and the PRACH configuration index and is given by
In case the PRACH configuration index is such that a PRACH resource occurs in every radio frame when calculated as below from Table 5.7.1-2 or Table 5.7.1-4,

$${n}_{PRB offset}^{RA} = \{ \begin{matrix}{\overline{n}}_{PRB offset}^{RA} & if {n}_{f} mod 2 = 0 \\ ( {\overline{n}}_{PRB offset}^{RA} + {f}_{PRB , hop}^{PRACH} ) mod {N}_{RB}^{UL} & if {n}_{f} mod 2 = 1\end{matrix}$$

$$otherwise$$

$${n}_{PRB offset}^{RA} = \{ \begin{matrix}{\overline{n}}_{PRB offset}^{RA} & if ⌊ \frac{{n}_{f} mod 4}{2} ⌋ = 0 \\ ( {\overline{n}}_{PRB offset}^{RA} + {f}_{PRB , hop}^{PRACH} ) mod {N}_{RB}^{UL} & if ⌊ \frac{{n}_{f} mod 4}{2} ⌋ = 1\end{matrix} ,$$

where nₜ is the system frame number corresponding to the first subframe for each PRACH repetition, and

$${f}_{PRB , hop}^{PRACH}$$

corresponds to a cell-specific higher-layer parameter prach-HoppingOffset. If frequency hopping is not enabled for the PRACH configuration, then

$${n}_{PRB offset}^{RA} = {\overline{n}}_{PRB offset}^{RA} .$$

For frame structure type 1 with preamble format 0-3, for each of the PRACH configurations there is at most one random access resource per subframe.

For frame structure type 2 with preamble formats 0-4, for each of the PRACH configurations there might be multiple random access resources in an UL subframe (or UpPTS for preamble format 4) depending on the UL/DL configuration [see table 4.2-2]. Table 5.7.1-3 lists PRACH configurations allowed for frame structure type 2 where the configuration index corresponds to a certain combination of preamble format, PRACH density value, DRA and version index, r_{RA}.

For frame structure type 2 with PRACH configuration indices 0, 1, 2, 20, 21, 22, 30, 31, 32, 40, 41, 42, 48, 49, 50, or with PRACH configuration indices 51, 53, 54, 55, 56, 57 in UL/DL configuration 3, 4, 5, the UE may for handover purposes assume an absolute value of the relative time difference between radio frame in the current cell and the target cell is less than 153600. Ts.

Table 5.7.1-3: Frame structure type 2 random access configurations for preamble formats 0-4

TABLE 5.7.1-3
Frame structure type 2 random access configuration
for preamble formats 0-4

| PRACH | | Density | |
|---|---|---|---|
| configuration | Preamble | Per 10 ms | Version |
| Index | Format | D_{RA} | r_{RA} |
| 0 | 0 | 0.5 | 0 |
| 1 | 0 | 0.5 | 1 |
| 2 | 0 | 0.5 | 2 |
| 3 | 0 | 1 | 0 |
| 32 | 2 | 0.5 | 2 |
| 33 | 2 | 1 | 0 |
| 34 | 2 | 1 | 1 |
| 35 | 2 | 2 | 0 |

Table 5.7.1-4 lists the mapping to physical resources for the different random access opportunities needed for a certain PRACH density value, DRA. Each quadruple of the format

$$( {f}_{RA} , {t}_{RA}^{( 0 )} , {t}_{RA}^{( 1 )} , {t}_{RA}^{( 2 )} )$$

indicates the location of a specific random access resource, where f_{RA} is a frequency resource index within the considered time instance,

$${t}_{RA}^{( 0 )} = 0 , 1 , 2$$

indicates respectively whether the resource is reoccurring in all radio frames, in even radio frames, or in odd radio frames, respectively;

$${t}_{RA}^{( 1 )} = 0 , 1$$

indicates whether the random access resource is located in first half frame or in second half frame, respectively; and where

$${t}_{RA}^{( 2 )}$$

is the uplink subframe number where the preamble starts, counting from 0 at the first uplink subframe between 2 consecutive downlink-to-uplink switch points, with the exception of preamble format 4 where

$${t}_{RA}^{( 2 )}$$

is denoted as (*). The start of the random access preamble formats 0-3 is aligned with the start of the corresponding uplink subframe at the UE assuming N_{TA}=0, and the random access preamble format 4 starts 4832·T_{g} before the end of the UpPTS at the UE, where the UpPTS is referenced to the UE's uplink frame timing assuming N_{TA}=0.

The random access opportunities for each PRACH configuration are allocated in time first and then in frequency if and only if time multiplexing is not sufficient to hold all opportunities of a PRACH configuration needed for a certain density value without overlap in time. For preamble formats 0-3, the frequency multiplexing shall be done according to

$${n}_{PRB}^{RA} = \{ \begin{matrix}{n}_{PRB offset}^{RA} + 6 ⌊ \frac{{f}_{RA}}{2} ⌋ , & if {f}_{RA} mod 2 = 0 \\ {N}_{RB}^{UL} - 6 - {n}_{PRB offset}^{RA} - 6 ⌊ \frac{{f}_{RA}}{2} ⌋ , & otherwise\end{matrix} ,$$

where

$${N}_{RB}^{UL}$$

is the number of uplink resource blocks,

$${n}_{PRB}^{RA}$$

is the first physical resource block allocated to the PRACH opportunity being considered, and where

$${n}_{PRB offset}^{RA}$$

is the first physical resource block available for PRACH.

For BL/CE UEs, only a subset of the subframes allowed for preamble transmission are allowed as starting subframes for the

$${N}_{rep}^{PRACH}$$

repetitions. The allowed starting subframes for a PRACH configuration are determined as follows:
Enumerate the subframes that are allowed for preamble transmission for the PRACH configuration as

$${n}_{sf}^{RA} = 0 , … , {N}_{sf}^{RA} - 1 , where {n}_{sf}^{RA} = 0 and {n}_{sf}^{RA} = {N}_{sf}^{RA} - 1$$

correspond to the two subframes allowed for preamble transmission with the smallest and the largest absolute subframe number

$${n}_{sf}^{abs} ,$$

respectively.
If a PRACH starting subframe periodicity

$${N}_{start}^{PRACH}$$

is not provided by higher layers, the periodicity of the allowed starting subframes in terms of subframes allowed for preamble transmission is

$${N}_{rep}^{PRACH} .$$

The allowed starting subframes defined over

$${n}_{sf}^{RA} = 0 , … {N}_{sf}^{RA} - 1$$

are given by

$${jN}_{rep}^{PRACH}$$

where j=0, 1, 2, . . . .
If a PRACH starting subframe periodicity

$${N}_{start}^{PRACH}$$

is provided by higher layers, it indicates the periodicity of the allowed starting subframes in terms of subframes allowed for preamble transmission. The allowed starting subframes defined over

$${n}_{sf}^{RA} = 0 , … {N}_{sf}^{RA} - 1 are given {jN}_{rep}^{PRACH}$$

by where j=0, 1, 2, . . . .

No starting subframe defined over

$${n}_{sf}^{RA} = 0 , … {N}_{sf}^{RA} - 1 such that {n}_{sf}^{RA} > {N}_{sf}^{RA} - {N}_{rep}^{PRACH}$$

is allowed.

Each random access preamble occupies a bandwidth corresponding to 6 consecutive resource blocks for both frame structures.

TABLE 5.7.1-4
Frame structure type 2 random access preamble mapping in time and frequency

| PRACH | | | | | | | |
|---|---|---|---|---|---|---|---|
| configuration Index | UL/DL configuration (See Table 4.2-2) | | | | | | |
| (See Table 5.7.1-3) | 0 | 1 | 2 | 3 | 4 | 5 | 6 |
| 0 | (0, 1, 0, 2) | (0, 1, 0, 1) | (0, 1, 0, 0) | (0, 1, 0, 2) | (0, 1, 0, 1) | (0, 1, 0, 0) | (0, 1, 0, 2) |
| 1 | (0, 2, 0, 2) | (0, 2, 0, 1) | (0, 2, 0, 0) | (0, 2, 0, 2) | (0, 2, 0, 1) | (0, 2, 0, 0) | (0, 2, 0, 2) |
| 2 | (0, 1, 1, 2) | (0, 1, 1, 1) | (0, 1, 1, 0) | (0, 1, 0, 1) | (0, 1, 0, 0) | N/A | (0, 1, 1, 1) |

### NB-IoT (Section 10.1.6 of 36.211 v17.2.0)

The physical layer random access preamble is based on single-subcarrier frequency-hopping symbol groups. A symbol group is illustrated in FIG. 10.1.6.1-1, consisting of a cyclic prefix of length T_{CP} and a sequence of N identical symbols with total length T_{SEQ}. The total number of symbol groups in a preamble repetition unit is denoted by P. The number of time-contiguous symbol groups is given by G.

TABLE 10.1.6.1-2
Random access preamble parameters for frame structure type 2

| | Supported | | | | | |
|---|---|---|---|---|---|---|
| | uplink- | | | | | |
| Preamble | downlink | | | | | |
| format | configurations | G | P | N | T_{CP} | T_{SEQ} |
| 0 | 1, 2, 3, 4, 5 | 2 | 4 | 1 | 4768Tₛ | 1 · 8192Tₛ |
| 1 | 1, 4 | 2 | 4 | 2 | 8192Tₛ | 2 · 8192Tₛ |
| 2 | 3 | 2 | 4 | 4 | 8192Tₛ | 4 · 8192Tₛ |
| 0-a | 1, 2, 3, 4, 5 | 3 | 6 | 1 | 1536Tₛ | 1 · 8192Tₛ |
| 1-a | 1, 4 | 3 | 6 | 2 | 3072Tₛ | 2 · 8192Tₛ |

The preamble consisting of P symbol groups shall be transmitted

$${N}_{rep}^{NPRACH}$$

times. For frame structure type 2, when an invalid uplink subframe overlaps the transmission of G symbol groups without a gap, the G symbol groups are dropped. For frame structure type 2, the transmission of G symbol groups is aligned with the subframe boundary.

The frequency location of the NPRACH transmission is constrained within

$${N}_{sc}^{RA} = 12$$

sub-carriers, and within

$${N}_{sc}^{RA} = 36$$

subcarriers when preamble format 2 as described in Table 10.1.6.1-1 is configured. Frequency hopping shall be used within the 12 subcarriers and 36 subcarriers when preamble format 2 as described in Table 10.1.6.1-1 is configured, where the frequency location of the i^{th} symbol group is given by

$${n}_{sc}^{RA} ( i ) = {n}_{start} + {\tilde{n}}_{SC}^{RA} ( i ) where {n}_{start} = {N}_{scoffset}^{NPRACH} + ⌊ {n}_{init} / {N}_{sc}^{RA} ⌋ \cdot {N}_{sc}^{RA} . The quantity {\tilde{n}}_{sc}^{RA} ( i )$$

depends on the frame structure.

### Msg1 Power Determination

7.4 of 38.213 v17.4.0 discusses Msg1 power determination.

A PRACH is transmitted using the selected PRACH format with transmission power P_{PRACH,b,f,c}(i) on the indicated PRACH resource, with BWP b of carrier f of serving cell c.

P_{PRACH,b,f,c}(i)=min{P_{CMAX,f,c}(i),P_{PRACH,target,b,f,c}(i)+PL_{b,f,c}} [dBm]

If, within a random access response window, as described in Clause 8.2, the UE does not receive a random access response that contains a preamble identifier corresponding to the preamble sequence transmitted by the UE, the UE determines a transmission power for a subsequent PRACH transmission, if any, as described in [11, TS 38.321].

If, prior to a PRACH retransmission, a UE changes the spatial domain transmission filter, Layer 1 notifies higher layers to suspend the power ramping counter as described in [11, TS 38.321].

5.1.3 of 38.321 v17.3.0

### Msg3 Transmission Power

7.1.1 of 38.213 v17.4.0 discusses Msg3 transmission power.

If a UE transmits a PUSCH on active UL BWP b of carrier f of serving cell (using parameter set configuration with index j and PUSCH power control adjustment state with index 1, the UE determines the PUSCH transmission power P_{PUSCH,b,f,c}(i, j, q_{d},1) in PUSCH transmission occasion i as

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

[dBm]
where, for the PUSCH power control adjustment state f_{b,f,c}(i,l) for active UL BWP b of carrier f of serving cell (in PUSCH transmission occasion i, if the UE receives a random access response message in response to a PRACH transmission on active UL BWP b of carrier f of serving cell (as described in Clause 8
   f_{b,f,c}(0,1)=ΔP_{rampup, b,f,c}+δ_{msg 2,b,f,c}, where l=0 and
      δ_{msg 2,b,f,c} is a TPC command value indicated in the random access response grant of the random access response message corresponding to the PRACH transmission on active UL BWP b of carrier f in the serving cell [symbol] , and

$$Δ {P}_{rampup , b , f , c} = min [ \{ max ( 0 , {P}_{CMAX , f , c} - ( \begin{matrix}10 {log}_{10} ( {2}^{μ} \cdot {M}_{RB , b , f , c}^{PUSCH} ( 0 ) ) + \\ {P}_{O \_ PUSCH , b , f , c} ( 0 ) + {α}_{b , f , c} ( 0 ) \cdot {PL}_{c} + \\ {Δ}_{TF , b , f , c} ( 0 ) + {δ}_{msg 2 , b , f , c}\end{matrix} ) ) \} , Δ {P}_{rampupprequested , b , f , c} ]$$

and ΔP_{rampuprequested,b,f,c} is provided by higher layers and corresponds to the total power ramp-up requested by higher layers from the first to the last random access preamble for carrier f in the serving cell [symbol] ,

$${M}_{RB , b , f , c}^{PUSCH} ( 0 )$$

is the bandwidth of the PUSCH resource assignment expressed in number of resource blocks for the first PUSCH transmission on active UL BWP b of carrier f of serving cell [symbol] , and Δ_{TF,b,f,c}(0) is the power adjustment of first PUSCH transmission on active UL BWP b of carrier f of serving cell [symbol] .

### Beam Failure Recovery

Section 9.2.8 in 38.300 v17.3.0 discusses beam failure recovery.

For beam failure detection, the gNB configures the UE with beam failure detection reference signals (SSB or CSI-RS), and the UE declares beam failure when the number of beam failure instance indications from the physical layer reaches a configured threshold before a configured timer expires. SSB-based Beam Failure Detection is based on the SSB associated to the initial DL BWP and can only be configured for the initial DL BWPs and for DL BWPs containing the SSB associated to the initial DL BWP. For other DL BWPs, Beam Failure Detection can only be performed based on CSI-RS.

After beam failure is detected, the UE:
triggers beam failure recovery by initiating a Random Access procedure on the PCell;
selects a suitable beam to perform beam failure recovery (if the gNB has provided dedicated Random Access resources for certain beams, those will be prioritized by the UE).

Upon completion of the Random Access procedure, beam failure recovery is considered complete.

### SUMMARY

It is an object of embodiments described herein to address at least some of the problems and issues outlined herein. It is possible to achieve these objects and others by using a user equipment, a network node, methods performed in the user equipment for performing an uplink transmission(s) and methods performed in the network node for scheduling an uplink transmission(s), as defined in the attached claims.

According to a first aspect of embodiments herein, the object is achieved by a method of a user equipment, UE, for performing an uplink, UL, transmission, the method comprising: determining an uplink, UL, duty cycle of the UL transmission including an unscheduled transmission; applying a power backoff setting to a transmission power for the UL transmission in response to the UL duty cycle being larger than capability information reported by the UE for compliance with electromagnetic power density exposure requirements, to determine an actual transmission power for performing the UL transmission; and transmitting the UL transmission using the actual transmission power.

According to a second aspect of embodiments herein, the object is achieved by a network node for scheduling an uplink, UL, transmission, the method comprising: receiving capability information reported by a user equipment, UE; scheduling the UL transmission according to the reported capability information; and receiving, from the UE, the UL transmission transmitted using an actual transmission power for performing the UL transmission; wherein the actual transmission power is obtained by applying a power backoff setting to a transmission power for the UL transmission in response to an UL duty cycle of the UL transmission including an unscheduled transmission being larger than the capability information.

According to a third aspect of embodiments herein, the object is achieved by a user equipment for performing an uplink, UL, transmission, the UE comprising: an antenna configured to send and receive wireless signals; a processing circuitry being configured to perform: determine an uplink, UL, duty cycle of the UL transmission including an unscheduled transmission; apply a power backoff setting to a transmission power for the UL transmission in response to the UL duty cycle being larger than capability information reported by the UE for compliance with electromagnetic power density exposure requirements, to determine an actual transmission power for performing the UL transmission; and transmit the UL transmission using the actual transmission power.

According to a fourth aspect of embodiments herein, the object is achieved by a network node for scheduling an uplink, UL, transmission, the network node comprising: an antenna configured to send and receive wireless signals; a processing circuitry being configured to perform: receive capability information reported by a user equipment, UE; schedule the UL transmission according to the reported capability information; and receive, from the UE, the UL transmission transmitted using an actual transmission power for performing the UL transmission; wherein the actual transmission power is obtained by applying a power backoff setting to a transmission power for the UL transmission in response to an UL duty cycle of the UL transmission including an unscheduled transmission being larger than capability information.

Embodiments of the present disclosure may improve the PRACH coverage and save the UE power. Embodiments of the present disclosure may also reduce the time duration for performing the procedure involving the PRACH transmission, e.g., cell change such as handover, RRC connection release with redirection, RRC connection re-establishment, acquisition of time advance command upon losing synchronization with respect to the serving cell, etc.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows a flow chart of a possible method embodiment under the present disclosure.

FIG. 2 shows another flow chart of a possible method embodiment under the present disclosure.

FIG. 3 shows another flow chart of a possible method embodiment under the present disclosure.

FIG. 4 shows another flow chart of a possible method embodiment under the present disclosure.

FIG. 5 shows another flow chart of a possible method embodiment under the present disclosure.

FIG. 6 shows another flow chart of a possible method embodiment under the present disclosure.

FIG. 7 shows another flow chart of a possible method embodiment under the present disclosure.

FIG. 8 shows an example of a communication system QQ100 in accordance with some embodiments.

FIG. 9 shows a UE QQ200 in accordance with some embodiments.

FIG. 10 shows a network node QQ300 in accordance with some embodiments.

FIG. 11 is a block diagram of a host QQ400, which may be an embodiment of the host QQ116 of FIG. 8, in accordance with various aspects described herein.

FIG. 12 is a block diagram illustrating a virtualization environment QQ500 in which functions implemented by some embodiments may be virtualized.

FIG. 13 shows a communication diagram of a host QQ602 communicating via a network node QQ604 with a UE QQ606 over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

There currently exist certain challenges. The 3GPP specification defines the UE behavior related to the maximum permissible exposure (MPE) requirement (e.g., specific absorption rate (SAR)), which are regulatory requirements). One is to set power management maximum power reduction (P-MPR) for a scheduled uplink based on calculation of the scheduled uplink duty cycle. However, such a mechanism is used for the network to schedule the uplink transmission, and as PRACH is not scheduled by network, the UE can apply P-MPR to meet the regulation requirement.

For a device (e.g., UE) operating on a carrier frequency above 10 GHz to meet the maximum permissive exposure (MPE) requirement, the incident power density measurement time is several seconds. For a device (e.g., UE) operating on a carrier frequency below or equal to 10 GHz, the SAR requirement will apply over an average time of 6 minutes. The UE is allowed to transmit with higher emission as long as the measurement averaged in the evaluation time window meets the MPE limit.

When the UE applies P-MPR for the PRACH, there is a coverage penalty for PRACH because the transmitted output power would be reduced and, therefore, a method is needed to avoid or minimize the reduction of the PRACH coverage.

In Rel-18, 3GPP introduces the multiple PRACH transmission, and if P-MPR is applied to PRACH transmission and the network fails to receive the PRACH, it may waste the PRACH occasion (RO) resource and increase interference with the PRACH success rate of other UEs. UE behavior of the MPE for unscheduled transmission needs to be specified to further improve the PRACH coverage in the network.

Certain aspects of the disclosure and their embodiments may provide solutions to these or other challenges. Certain embodiments of the disclosure describe a method for a UE to avoid setting power backoff due to meeting the MPE (P-MPR=0) for PRACH transmission.

In certain embodiments, the UE determines the P-MPR for transmission power of the PRACH transmission based on one or more of the following factors or criteria:
1. Number of the PRACH transmission(s)
2. Operating frequency (>10 GHz, or <10 GHz)
3. RACH type, e.g., Two-step RACH or Four-step RACH, contention based RACH, or non-contention based RACH, etc.
4. PRACH retransmission
5. PRACH repetition
6. Coexisting with other technology (WIFI, Bluetooth, 2G/3G/4G/5G)
7. Type of procedure or operations associated with the PRACH transmission, e.g., handover, beam failure recovery, for acquiring timing upon expiry of the time alignment timer (TAT) etc.

The UE applies the determined value (B) of the P-MPR to the estimated power (P1) for the PRACH transmission to determine the actual power (P2) for performing the PRACH transmission. The UE further transmits the PRACH transmission using the determined power, P2. In one example, P1 (in dBm), P2 (in dBm), and β (in dB) are related by the following function, (in one case, P1=PCmax)

P2=P1−β

This disclosure also includes methods of UE calculation of UL duty cycle and UE determination of P-MPR setting for unscheduled transmissions, e.g, PRACH. It applies for single PRACH transmission and multiple PRACH transmission. Whether a UE can set the P-MPR for unscheduled transmissions can be based on below factors when capability maxUplinkDutyCycle is present:
1. Percentage of the uplink symbols including the scheduled and/or unscheduled symbols
2. Whether the threshold indication of the max UplinkDutyCyle include both scheduled and unscheduled signal dutyCycle.

By specifying the UE behavior of the MPE for PRACH transmission, the network can improve the PRACH coverage.

Certain embodiments may provide one or more of the following technical advantages:
Improve the PRACH coverage and save UE power.
Reduce the time duration for performing the procedure involving the PRACH transmission, e.g., cell change such as handover, RRC connection release with redirection, RRC connection re-establishment, acquisition of time advance command upon losing synchronization with respect to the serving cell, etc.

For the UE to meet the MPE requirement, the measurement on the power density or the rate at which energy is absorbed per unit mass by a human body when exposed to a radio frequency (RF) electromagnetic field (e.g., Specific Absorption Rate) can be averaged within a certain time window. For a UE operating below 10 GHz, the measurement of an SAR (Specific Absorption Rate) limit can be averaged over a 6 minute time window. For a UE operating above 10 GHz, the measurement for incident power density can be averaged over several seconds. If the UE transmits higher output power in a short time period, as long as the time average measurements within either SAR limit (W/kg) or power density (W/m²), the higher power transmission is allowed. This makes it possible to predefine the UE backoff power for one signal for a single transmission or transmissions that do not occur regularly to meet the exposure requirement, for example, PRACH transmission. As PRACH transmission may only occur at the configured slot to enable the UE to access the network, this PRACH symbol may only occupy a small portion of the total transmit symbols for a typical eMBB UE.

In one embodiment, the backoff power (P-MPR) applied to the maximum transmission power (e.g, Pcmax defined in TS 38.101-1 or TS 38.101-2) for PRACH transmission is a function of or depends on a scaling number/factor, K dB, which can be pre-defined or configured by a network node (e.g., by the serving BS of the UE). In one example, the UE transmit power (P2) (dBm) for PRACH transmission after applying the P-MPR is determined as follows:

P2=PCmax−K

The UE transmits the PRACH using the transmission power, P2.

For the first PRACH transmission without repetition, K=0 dB when there is no simultaneous transmission from another radio access technology (e.g., WIFI/Bluetooth/2G/3G/4G) coexisting in-device with UE, i.e., simultaneous transmissions of the PRACH and another signal by the UE. Any two uplink transmissions by the same UE are considered to be simultaneous provided that they at least partially overlap with respect to each other in time. When simultaneous transmission occurs, K could also be set to 0 dB if the UE can compensate the time-averaged output power in one or more subsequent consecutive transmissions. In another case, K can be set to K>0 dB (e.g., X1 dB), which may further depend on the simultaneous transmission from other technology e.g., transmit power on the other technology. For example, if UE total transmission power would exceed the SAR or power density requirement due to the simultaneous transmission of different transmitters for different technologies or simultaneous transmissions from different transmitters of the same technology, if UE would apply a scaling factor to reduce its total transmission power, such scaling factor needs to be compared with K dB and should be less than K dB for PRACH transmission. In another case, K can be set to X2 dB, which depends on the simultaneous transmission of PRACH on one carrier frequency (F1) and a non-PRACH signal on another carrier frequency (e.g., F2). Examples of the non-PRACH signal are an UL reference signal (e.g., SRS, DMRS etc), an UL control channel (e.g., PUCCH), an UL data channel (e.g., PUSCH), etc. In one example, X2 is below certain threshold. In another example, X2 is above certain threshold. In another example, X2=0 dB.

In another embodiment, the backoff power (P-MPR) does not apply to the first transmission of PRACH transmission but can be applied to the maximum transmission power for PRACH transmission(s) (e.g., subsequent transmissions) other than the first PRACH transmission which can be set by the UE, and in some cases, UE can set P-MPR with an additional scaling number/factor of M dB. This M dB could be associated with backoff power for the other PRACH transmission than the first transmission, for example, for the PRACH transmission which is ramping up transmission power for re-attempt or retransmission, the additional M dB would be allowed at the cases mentioned above (e.g., the simultaneous transmission of PRACH and other uplink signal by UE).

P-MPR for other PRACH transmission=K dB+M dB

In this case, P2 is determined as follows:

P2=PCmax−(K+M)

This is to compensate for the high transmission power for the first PRACH transmission. In one example, M can be pre-defined or configured by a network node. In another example, the K and/or M can be reported by the UE to a network node as UE capability depending on the UE power class and/or number of the coexisting in-device technologies supported on the same UE device. In another example, the K and/or M can be reported by the UE to a network node as part of the UE assistance information (UAI). In this case the values of K and/or M can vary over time semi-statically or dynamically. For example, the values of the K and/or M depends on the currently used UE power class and/or number of the coexisting in-device technologies currently used on the same UE device.

The above equation is under the assumption that the first and the subsequent PRACH transmissions are multiple PRACH transmissions of the same RACH attempt, which apply the same power ramping counter according to the following agreement in RAN1 #112.

### Agreement

For multiple PRACH transmissions with same Tx beam in one RACH attempt, transmission power ramping is not applied within one RACH attempt.

In another embodiment, if the subsequent PRACH is the retransmission of the first PRACH transmission and has a PREAMBLE_POWER_RAMPING_COUNTER 1 larger than that of the first transmission, P2 is determined as follows:

P2=min(PCmax−(K+M),previous transmission power+power ramping step)

In another embodiment, the P-MPR applied to the transmission power for each of the PRACH transmission depends on the number (Np) of PRACH transmissions. The parameter Np may correspond to the maximum number of the PRACH transmissions or the maximum number of the PRACH retransmissions configured by a network node. For example, the P-MPR value (L) per PRACH transmission or per PRACH retransmission can be expressed as follows:

L=H/Np

where H is the aggregated or total amount of the P-MPR which the UE can apply during all the PRACH transmissions or all the PRACH retransmissions. In one example, H is expressed in dB. In another example, H is expressed in linear scale.

The UE determines and applies the P2 during each PRACH transmission or each PRACH retransmission as follows, where L is in dB:

P2=P1−L

where P1 is the UE transmission power or estimated transmission power for PRACH.

In another embodiment, the P-MPR applied to the transmission power of the PRACH transmission is adapted or adjusted based on or depending on the purpose of the PRACH transmission. The purpose depends on the type of the procedure during which the PRACH is transmitted or type of the procedure which triggers the UE to perform the PRACH transmission. In one example, the no P-MPR (i.e., P-MPR=0) is applied or the applied P-MPR to the PRACH transmission power is below threshold (e.g., no more than 2 dB) for at least the first PRACH transmission related to one or more critical operations. During some of the critical operations or in response to the occurrence of the critical operations, the UE transmits the PRACH. Examples of such critical operations are cell change, expiration of timing advance (TA) command, RRC connection re-establishment, beam failure detection (BFD), beam failure recovery (BFR), tracking area or registration area update, etc. Examples of the cell change are handover, cell reselection, RRC connection release with redirection, serving cell (e.g., SCell, PSCell, etc.) change, etc. For example, the P-MPR applied to the transmission power of the PRACH transmission for normal operations (i.e., non-critical operations) can be X1 dB. On the other band, the P-MPR applied to the transmission power of the PRACH transmission for critical operations can be X2 dB; where X1>X2 e.g., X1=3 dB and X2=1 dB or X1=2 dB and X2=0 dB. The value of the P-MPR (e.g., X2) may further depend on the type of the critical operations e.g., X2=2 dB for PRACH transmission during the handover, X2=1 dB for PRACH transmission during the BFR procedure, X2=0 dB for PRACH transmission upon expiration of the TA command etc. The TA command is expired or becomes invalid when the time alignment timer (TAT) expires.

In another embodiment, the P-MPR applied to the transmission power of the PRACH transmission is adapted or adjusted based on or depending on the type of PRACH procedure used for the PRACH transmission. The UE applies the adapted P-MPR value to the estimated PRACH transmission power (P1) to determine the actual PRACH transmission power (P2). The UE further transmits the PRACH using the determined value of P1. Examples of the types of the PRACH procedure are: contention-based RACH, non-contention-based RACH, 2-step RACH, 4-step RACH, etc. This is explained with examples below:
In one example, the P-MPR value (e.g., Y1 dB) is lower for transmission power used for the contention-based PRACH transmission compared to the P-MPR value (e.g., Y2 dB) for transmission power used for the non-contention-based PRACH transmission.
In another example, the P-MPR value (e.g., Y1 dB) is higher for transmission power used for the PRACH transmission compared to the P-MPR value (e.g., Y2 dB) for transmission power used for the non-contention-based PRACH transmission.
In another example, the magnitude of the different between Y1 and Y2 is larger than certain threshold (G1) e.g., (|Y1−Y2|>G1).
In another example, the magnitude of the different between Y1 and Y2 is smaller than or equal to certain threshold (G2) but greater than 0 dB e.g., (0<|Y1−Y2|≤G2).
In another example, the P-MPR value (e.g., Y3 dB) is lower for transmission power used for the 2-step PRACH transmission compared to the P-MPR value (e.g., Y4 dB) for transmission power used for the 4-step PRACH transmission.
In another example, the P-MPR value (e.g., Y3 dB) is higher for transmission power used for the 2-step PRACH transmission compared to the P-MPR value (e.g., Y4 dB) for transmission power used for the 4-step PRACH transmission.
In another example, the magnitude of the different between Y3 and Y4 is larger than certain threshold (G3) e.g., (|Y3−Y4|>G3).
In another example, the magnitude of the different between Y3 and Y4 is smaller than or equal to certain threshold (G4) but greater than 0 dB e.g., (0<|Y3−Y4|≤G4).

In another embodiment, during certain PRACH procedure if the aggregated value (Z) of the P-MPR applied to the transmission power of one or more PRACH transmissions exceed certain threshold (H2) then the UE performs one or more operational tasks. The aggregated value of the P-MPR is determined based on one or more functions, e.g., sum, maximum, product, ceiling, etc. For example, if P-MPR values corresponding to z1, z2, and z3 are applied by the UE to the transmission powers of the first, second, and third PRACH transmissions, respectively, then in one example the aggregated value (Z) of the P-MPR is expressed as:

Z=z1+z2+z3

Examples of the one or more operational tasks are:
In one example, the UE stops performing PRACH transmission e.g., the UE abandons or discards the PRACH procedure.
In another example, the UE restarts the PRACH procedure. In this case the UE abandons or discards the previous PRACH procedure.
In another example, the UE switches to another PRACH procedure.
   In one example, if the UE was performing the 2-step RACH then upon Z exceeding H2, the UE switches to 4-step RACH. In this case, the UE further starts performing the PRACH procedure using the 4-step RACH.
   In another example, if the UE was performing the 4-step RACH then upon Z exceeding H2, the UE switches to 2-step RACH. In this case, the UE further starts performing the PRACH procedure using the 2-step RACH.
In another example, the UE switches to anther PRACH procedure provided that Z exceeds H2, and the UE does not receive any random access response (RAR) message from a network node.
   In one example, if the UE was performing the 2-step RACH then upon Z exceeding H2 and upon not receiving the RAR message, the UE switches to 4-step RACH. In this case, the UE further starts performing the PRACH procedure using the 4-step RACH.
   In another example, if the UE was performing the 4-step RACH then upon Z exceeding H2 and upon not receiving the RAR message, the UE switches to 2-step RACH. In this case, the UE further starts performing the PRACH procedure using the 2-step RACH.

### Embodiment to Enhance the dutyCycle Capability

In 38.306, UE capability of maxUplinkDutyCycle-FR2 is defined as follows. This parameter is for the purpose of gNB scheduling. If gNB schedules the percentage of UL transmissions within an evaluation period equal to the reported capability, it doesn't expect any UE transmission power backoff to happen.

maxUplinkDutyCycle-FR2
Indicates the maximum percentage of symbols during 1s that can be scheduled for uplink
transmission at the UE maximum transmission power, so as to ensure compliance with
applicable electromagnetic power density exposure requirements provided by regulatory
bodies. This field is applicable for all power classes UE in FR2 as specified in TS 38.101-2
[3]. Value n15 corresponds to 15%, value n20 corresponds to 20% and so on. If the field is
absent or the percentage of uplink symbols transmitted within any 1s evaluation period is
larger than maxUplinkDutyCycle-FR2, the UE behaviour is specified in TS 38.101-2 [3].
This capability is not applicable to IAB-MT.

According to the TS 38.101-2 below, if a UE reports maxUplinkDutyCycle-FR2, it will perform a 2-step procedure. In step 1, it calculates uplink duty cycle, namely the percentage of uplink symbols transmitted within any Is evaluation period. If it exceeds the threshold provided by UE, in step 2, UE can apply the P-MPR.
If the field of UE capability maxUplinkDutyCycle-FR2 is present and the percentage of uplink symbols transmitted within any 1 s evaluation period is larger than maxUplinkDutyCycle-FR2, the UE follows the uplink scheduling and can apply P-MPR_{f,c}.
If the field of UE capability maxUplinkDutyCycle-FR2 is absent, the compliance to electromagnetic power density exposure requirements are ensured by means of scaling down the power density or by other means.

With the assumption that the capability of max UplinkDutyCycle is for the scheduled uplink resource only as it is specified in 38.306 v17.3.0, namely a gNB schedules UL transmissions according to the reported capability and expects no UE transmission power backoff. We have the following embodiments.

One embodiment is that when maxUplinkDutyCycle-FR2 is present, UE will calculate UL duty cycle including both scheduled and unscheduled symbols. In other words, all UL symbols transmitted, no matter whether they are scheduled or not, are taken into account in the UE calculation of UL duty cycle.

For example, the modified specification in TS 38.306 could be:

maxUplinkDutyCycle-FR2
Indicates the maximum percentage of symbols during Is that can be scheduled for uplink transmission at the UE maximum transmission power including unscheduled transmission, if any, so as to ensure compliance with applicable electromagnetic power density exposure requirements provided by regulatory bodies. This field is applicable for all power classes UE in FR2 as specified in TS 38.101-2 [3]. Value n15 corresponds to 15%, value n20 corresponds to 20% and so on. If the field is absent or the percentage of uplink symbols transmitted within any 1 s evaluation period is larger than maxUplinkDutyCycle-FR2, the UE behaviour is specified in TS 38.101-2 [3]. This capability is not applicable to IAB-MT.

Alternatively, One another example of the modified specification in TS 38.101-2 could be:
If the field of UE capability maxUplinkDutyCycle-FR2 is present and the percentage of uplink symbols transmitted within any 1 s evaluation period is larger than maxUplinkDutyCycle-FR2, the UE follows the uplink scheduling, if any, and can apply P-MPR_{f,c}.

Alternatively, the modified specification In TS 38.101-2 could be:
If the field of UE capability maxUplinkDutyCycle-FR2 is present and the percentage of uplink symbols transmitted within any 1 s evaluation period is larger than maxUplinkDutyCycle-FR2, the UE can apply P-MPR_{f,c}.

One example of the modified specification in TS 38.101-2 could be:
If the field of UE capability maxUplinkDutyCycle-FR2 is present and the percentage of uplink symbols transmitted including any unscheduled symbols within any 1 s evaluation period is larger than maxUplinkDutyCycle-FR2, the UE follows the uplink scheduling and can apply P-MPR_{f,c}.

Another embodiment is that UE report a new capability for dutyCycleCaculation which is different from the existing capability of max UplinkDutyCycle-FR2. Such capability may only relate to the P-MPR setting for autonomous transmission for the UE, e.g., PRACH.

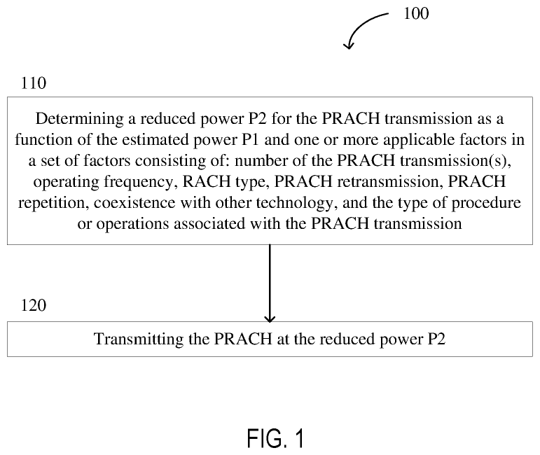

FIG. 1 shows a flow chart of a possible method embodiment under the present disclosure. Method 100 is a method performed by a UE for improving power usage. Step 110 is determining a reduced power P2 for the PRACH transmission as a function of the estimated power P1 and one or more applicable factors in a set of factors consisting of: number of the PRACH transmission(s), operating frequency, RACH type, PRACH retransmission, PRACH repetition, coexistence with other technology, and the type of procedure or operations associated with the PRACH transmission. Step 120 is transmitting the PRACH at the reduced power P2. Method 100 can comprise a variety of additional or alternative steps.

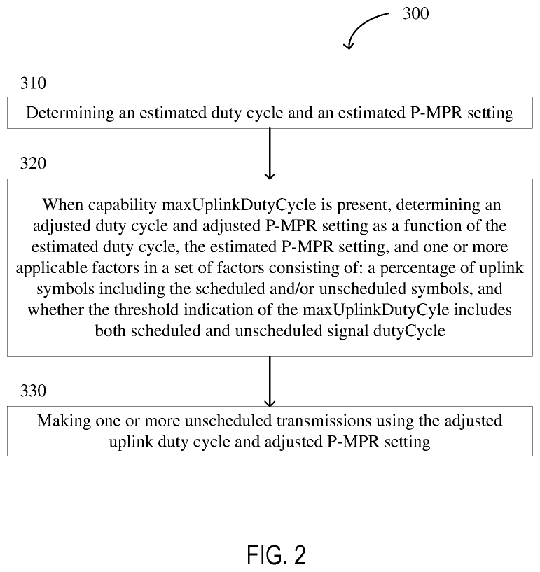

FIG. 2 shows another flow chart of a possible method embodiment under the present disclosure Method 300 is a method of UE calculation of uplink duty cycle and determination of P-MPR setting for unscheduled transmissions. Step 310 is determining an estimated duty cycle and an estimated P-MPR setting. Step 320 is, when capability maxUplinkDutyCycle is present, determining an adjusted duty cycle and adjusted P-MPR setting as a function of the estimated duty cycle, the estimated P-MPR setting, and one or more applicable factors in a set of factors consisting of: a percentage of uplink symbols including the scheduled and/or unscheduled symbols, and whether the threshold indication of the maxUplinkDutyCyle includes both scheduled and unscheduled signal dutyCycle. Step 330 is making one or more unscheduled transmissions using the adjusted uplink duty cycle and adjusted P-MPR setting. Method 300 can comprise a variety of additional or alternative steps.

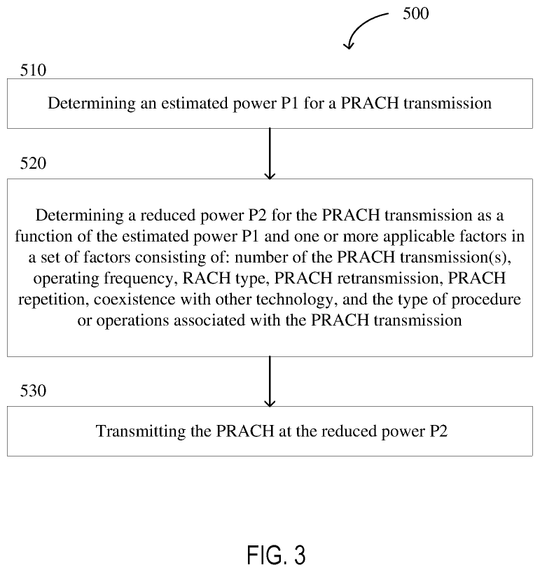

FIG. 3 shows another flow chart of a possible method embodiment under the present disclosure Method 500 is a (computer implemented) method for improving power usage of user equipment. Step 510 is determining an estimated power P1 for a PRACH transmission. Step 520 is determining a reduced power P2 for the PRACH transmission as a function of the estimated power P1 and one or more applicable factors in a set of factors consisting of: number of the PRACH transmission(s), operating frequency, RACH type, PRACH retransmission, PRACH repetition, coexistence with other technology, and the type of procedure or operations associated with the PRACH transmission. Step 530 is transmitting the PRACH at the reduced power P2. Method 500 can comprise a variety of additional or alternative steps.

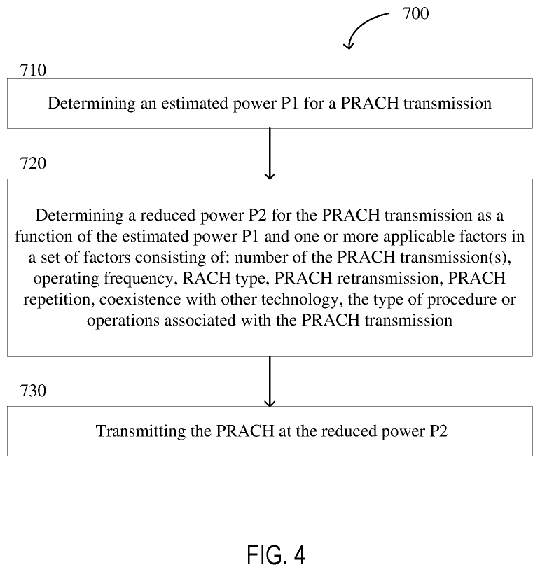

FIG. 4 shows another flow chart of a possible method embodiment under the present disclosure. Method 700 is a method performed by a network node for improving power usage. Step 710 is determining an estimated power P1 for a PRACH transmission. Step 720 is determining a reduced power P2 for the PRACH transmission as a function of the estimated power P1 and one or more applicable factors in a set of factors consisting of: number of the PRACH transmission(s), operating frequency, RACH type, PRACH retransmission, PRACH repetition, coexistence with other technology, the type of procedure or operations associated with the PRACH transmission. Step 730 is transmitting the PRACH at the reduced power P2. Method 700 can comprise a variety of additional or alternative steps.

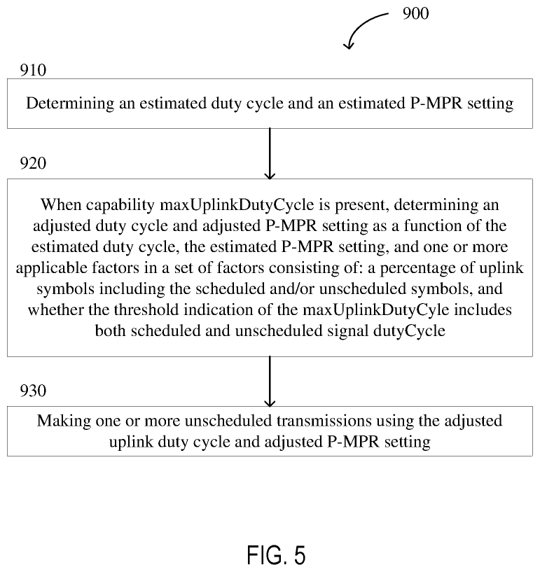

FIG. 5 shows another flow chart of a possible method embodiment under the present disclosure. Method 900 is a method performed by a network node of calculation of uplink duty cycle and determination of P-MPR setting for unscheduled transmissions. Step 910 is determining an estimated duty cycle and an estimated P-MPR setting. Step 920 is, when capability maxUplinkDutyCycle is present, determining an adjusted duty cycle and adjusted P-MPR setting as a function of the estimated duty cycle, the estimated P-MPR setting, and one or more applicable factors in a set of factors consisting of: a percentage of uplink symbols including the scheduled and/or unscheduled symbols, and whether the threshold indication of the max UplinkDutyCyle includes both scheduled and unscheduled signal dutyCycle. Step 930 is making one or more unscheduled transmissions using the adjusted uplink duty cycle and adjusted P-MPR setting. Method 900 can comprise a variety of additional or alternative steps.

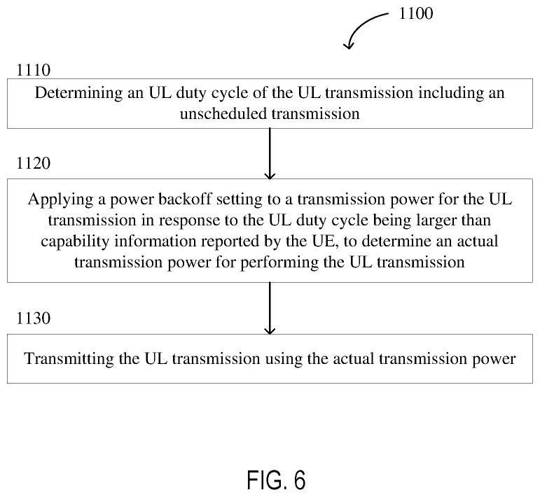

FIG. 6 shows another flow chart of a possible method embodiment under the present disclosure. Method 1100 is a method performed by a UE for performing an UL transmission. The method 1100 comprises:

Step 1110: determining an UL, duty cycle of the UL transmission including an unscheduled transmission.

Step 1120: applying a power backoff setting to a transmission power for the UL transmission in response to the UL duty cycle being larger than capability information reported by the UE, to determine an actual transmission power for performing the UL transmission. The power backoff is applied for compliance with electromagnetic power density exposure requirements.

Step 1130: transmitting the UL transmission using the actual transmission power.

In some embodiments, the unscheduled transmission includes a physical random access channel, PRACH, transmission.

In some embodiments, the capability information indicates a maximum percentage of symbols during Is that can be scheduled for the UL transmission at a maximum UE transmission power.

In some embodiments, the power backoff setting comprises a power management maximum power reduction, P-MPR.

In some embodiments, the actual transmission power for performing the UL transmission is a reduced power from the transmission power for the UL transmission.

In some embodiments, the transmission power is one of a maximum UE transmission power or a transmission power estimated by the UE.

In some embodiments, the power backoff setting is adjusted based on one or more following factors: purpose of a PRACH transmission, number of the PRACH transmission(s), operating frequency, type of a RACH procedure, PRACH retransmission, PRACH repetition, coexistence with other technology, and the type of procedure or operations associated with the PRACH transmission.

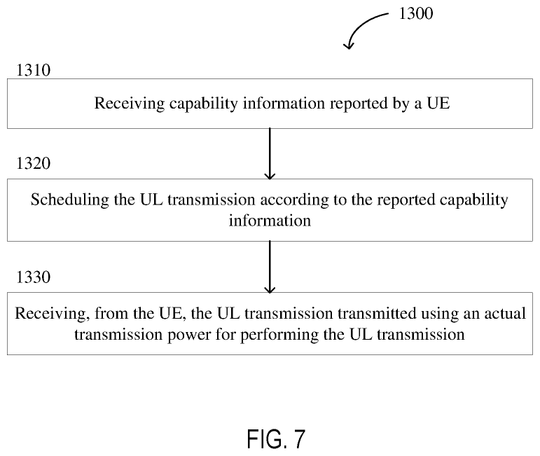

FIG. 7 shows another flow chart of a possible method embodiment under the present disclosure. Method 1300 is a method performed by a network node for scheduling an UL transmission. The method 1300 comprises:

Step 1310: receiving capability information reported by a UE.

Step 1320: scheduling the UL transmission according to the reported capability information.

Step 1330: receiving, from the UE, the UL transmission transmitted using an actual transmission power for performing the UL transmission.

In the method 1300, the actual transmission power is obtained by applying a power backoff setting to a transmission power for the UL transmission in response to an UL duty cycle of the UL transmission including an unscheduled transmission being larger than the capability information.

In some embodiments, the unscheduled transmission includes a physical random access channel, PRACH, transmission.

In some embodiments, the capability information indicates a maximum percentage of symbols during Is that can be scheduled for the UL transmission at a maximum UE transmission power.

In some embodiments, the power backoff setting comprises a power management maximum power reduction, P-MPR.

In some embodiments, the actual transmission power for performing the UL transmission is a reduced power from the transmission power for the UL transmission.

In some embodiments, the transmission power is one of a maximum UE transmission power or a transmission power estimated by the UE.

In some embodiments, the power backoff setting is adjusted based on one or more following factors: purpose of a PRACH transmission, number of the PRACH transmission(s), operating frequency, type of a RACH procedure, PRACH retransmission, PRACH repetition, coexistence with other technology, and the type of procedure or operations associated with the PRACH transmission.

According to some embodiments of the present application, a UE for performing UL transmission(s) is provided. The UE comprises: an antenna configured to send and receive wireless signals; a processing circuitry being configured to perform: determine an uplink, UL, duty cycle of the UL transmission including an unscheduled transmission; apply a power backoff setting to a transmission power for the UL transmission in response to the UL duty cycle being larger than capability information reported by the UE for compliance with electromagnetic power density exposure requirements, to determine an actual transmission power for performing the UL transmission; and transmit the UL transmission using the actual transmission power.

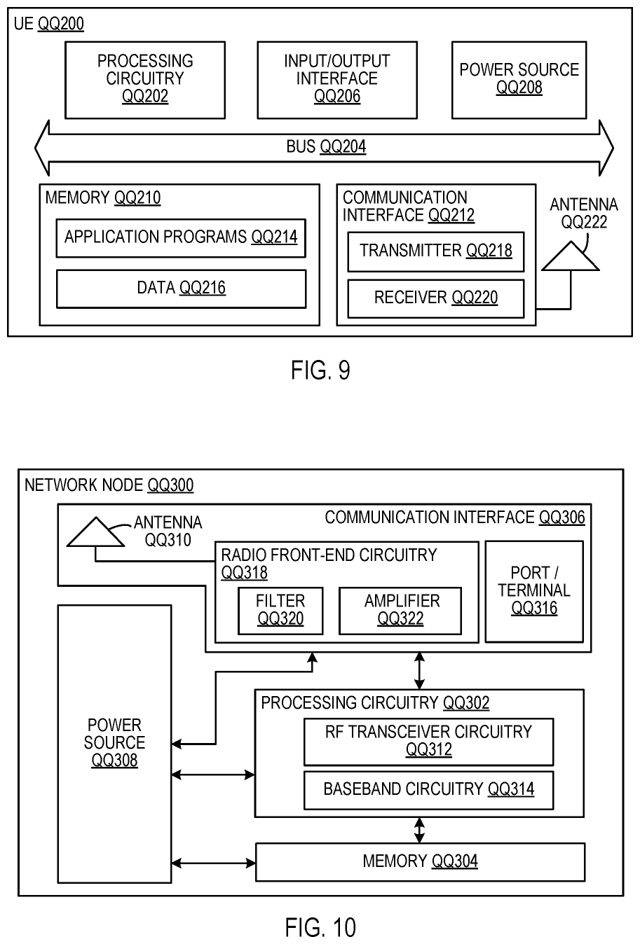

One example of such UE may be the UE QQ200 illustrated in FIG. 9. For example, the UE QQ200 could be configured to perform the actions described above according to FIG. 6.

According to some embodiments of the present application, a network node for scheduling UL transmission(s) is provided. The network node comprises: an antenna configured to send and receive wireless signals; a processing circuitry being configured to perform: receive capability information reported by a user equipment, UE; schedule the UL transmission according to the reported capability information; and receive, from the UE, the UL transmission transmitted using an actual transmission power for performing the UL transmission; wherein the actual transmission power is obtained by applying a power backoff setting to a transmission power for the UL transmission in response to an UL duty cycle of the UL transmission including an unscheduled transmission being larger than capability information.

One example of such network node may be the network node QQ300 illustrated in FIG. 10. For example, the network node QQ300 could be configured to perform the actions described above according to FIG. 7.

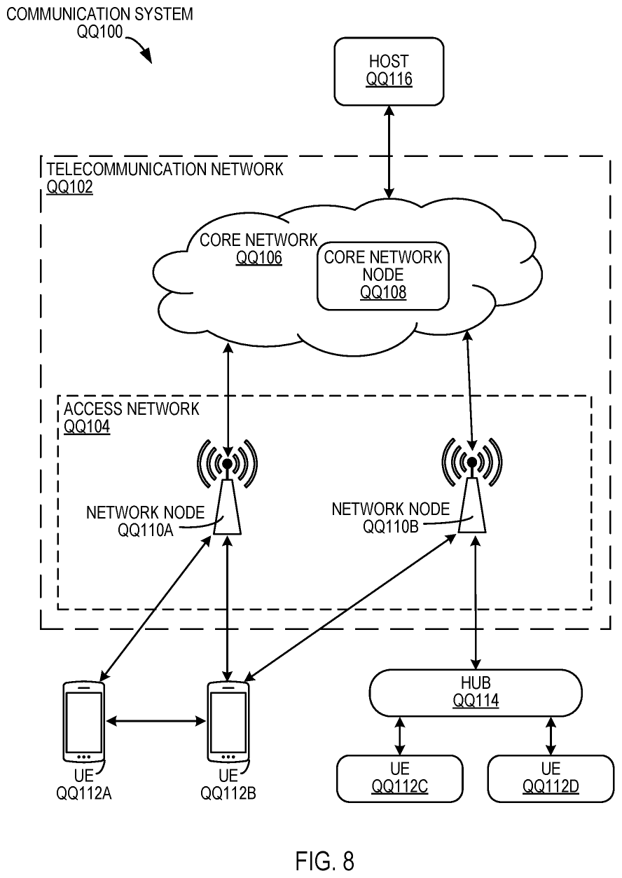

FIG. 8 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102 and may be operated by the service provider or on behalf of the service provider. The host QQ116 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular, if one or more of the UEs are low-energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 9 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-Bluetooth, near-field communication, location-based range communications such as communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (Aps) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 10 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

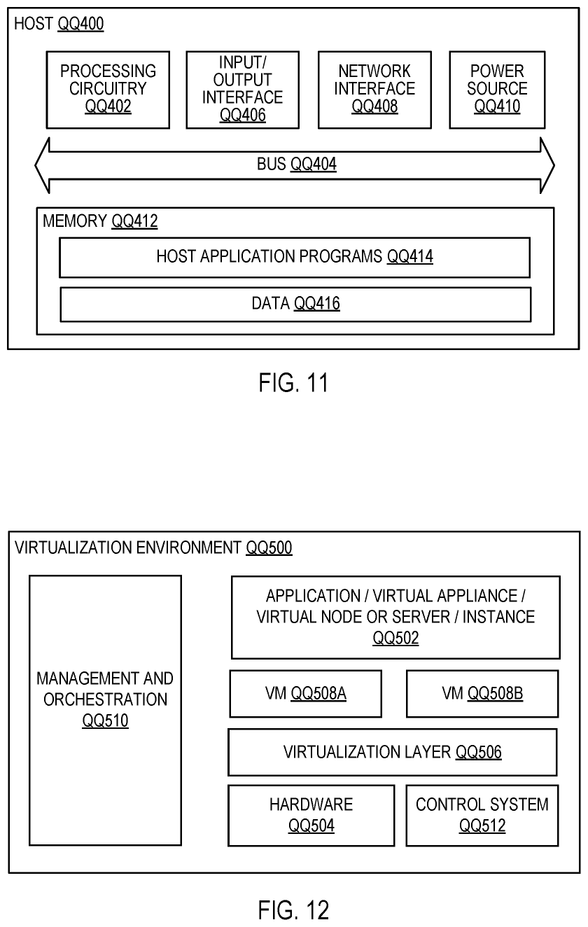

FIG. 11 is a block diagram of a host QQ400, which may be an embodiment of the host QQ116 of FIG. 8, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments.

Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g., such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

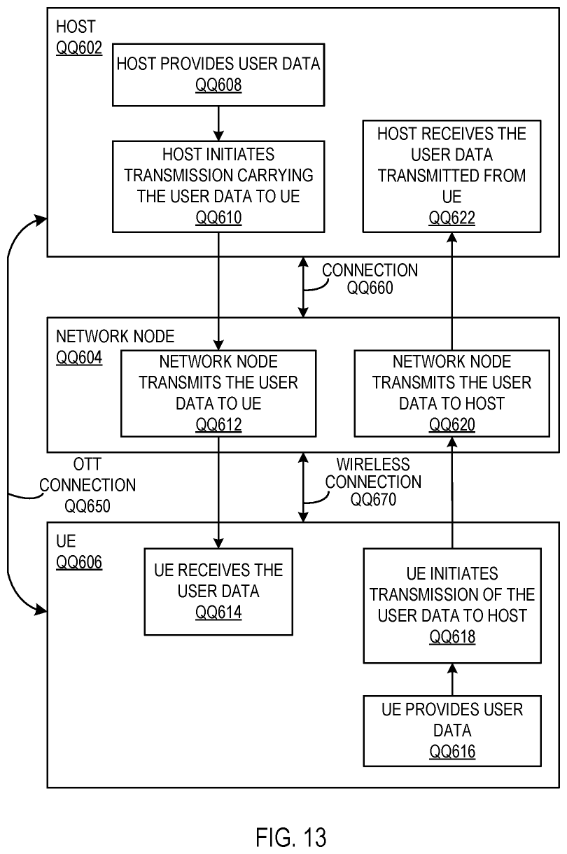

FIG. 13 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 8 and/or UE QQ200 of FIG. 9), network node (such as network node QQ110a of FIG. 8 and/or network node QQ300 of FIG. 10), and host (such as host QQ116 of FIG. 8 and/or host QQ400 of FIG. 11) discussed in the preceding paragraphs will now be described with reference to FIG. 13.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 8) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the data rate, latency, or power consumption and thereby provide benefits such as reduced user waiting time, relaxes restriction on file size, improved content resolution, better responsiveness, and extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or “dummy” messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

Some example embodiments of the present disclosure are as follows:

### Embodiments

### Group A Embodiments

1. A method performed by a user equipment for improving power usage, the method comprising:
   determining an estimated power P1 for a PRACH transmission;
   determining a reduced power P2 for the PRACH transmission as a function of the estimated power P1 and one or more applicable factors in a set of factors consisting of:
      number of the PRACH transmission(s),
      operating frequency,
      RACH type,
      PRACH retransmission,
      PRACH repetition,
      coexistence with other technology. And
      the type of procedure or operations associated with the PRACH transmission; and
   transmitting the PRACH at the reduced power P2.
2. The method of embodiment 1, wherein the reduced power P2 is calculated as a differential from the estimated power P1, where the differential is determined as a function of the one or more factors.
3. The method of embodiment 2, wherein the estimated power P1 and the reduced power P2 are determined in dBm, and the differential is measured in dB.
4. A method of user equipment calculation of uplink duty cycle and determination of P-MPR setting for unscheduled transmissions, the method comprising the steps of:
   determining an estimated duty cycle and an estimated P-MPR setting;
   when capability maxUplinkDutyCycle is present, determining an adjusted duty cycle and adjusted P-MPR setting as a function of the estimated duty cycle, the estimated P-MPR setting, and one or more applicable factors in a set of factors consisting of:
      a percentage of uplink symbols including the scheduled and/or unscheduled symbols. And
      whether the threshold indication of the maxUplinkDutyCyle includes both scheduled and unscheduled signal dutyCycle; and
   making one or more unscheduled transmissions using the adjusted uplink duty cycle and adjusted P-MPR setting.
5. The method of any of the previous embodiments, further comprising:
   providing user data; and
   forwarding the user data to a host via the transmission to the network node.
6. A (computer implemented) method for improving power usage of user equipment, comprising:
   determining an estimated power P1 for a PRACH transmission;
   determining a reduced power P2 for the PRACH transmission as a function of the estimated power P1 and one or more applicable factors in a set of factors consisting of:
      number of the PRACH transmission(s),
      operating frequency,
      RACH type,
      PRACH retransmission,
      PRACH repetition,
      coexistence with other technology. And
      the type of procedure or operations associated with the PRACH transmission; and
transmitting the PRACH at the reduced power P2.
7. A system for improving power usage, comprising processing circuitry and a memory, the memory containing instructions executable by the processing circuitry whereby the system/apparatus is operative to:
   determining an estimated power P1 for a PRACH transmission;
   determining a reduced power P2 for the PRACH transmission as a function of the estimated power P1 and one or more applicable factors in a set of factors consisting of:
      number of the PRACH transmission(s),
      operating frequency,
      RACH type,
      PRACH retransmission,
      PRACH repetition,
      coexistence with other technology. And
      the type of procedure or operations associated with the PRACH transmission; and
   transmitting the PRACH at the reduced power P2.

### Group B Embodiments

8. A method performed by a network node for improving power usage, the method comprising: determining an estimated power P1 for a PRACH transmission;
   determining a reduced power P2 for the PRACH transmission as a function of the estimated power P1 and one or more applicable factors in a set of factors consisting of:
      number of the PRACH transmission(s),
      operating frequency,
      RACH type,
      PRACH retransmission,
      PRACH repetition,
      coexistence with other technology. And
      the type of procedure or operations associated with the PRACH transmission; and
   transmitting the PRACH at the reduced power P2.
9. The method of embodiment 8, wherein the reduced power P2 is calculated as a differential from the estimated power P1, where the differential is determined as a function of the one or more factors.
10. The method of embodiment 9, wherein the estimated power P1 and the reduced power P2 are determined in dBm, and the differential is measured in dB.
11. A method performed by a network node of calculation of uplink duty cycle and determination of P-MPR setting for unscheduled transmissions, the method comprising the steps of:
   determining an estimated duty cycle and an estimated P-MPR setting;
   when capability maxUplinkDutyCycle is present, determining an adjusted duty cycle and adjusted P-MPR setting as a function of the estimated duty cycle, the estimated P-MPR setting, and one or more applicable factors in a set of factors consisting of:
      a percentage of uplink symbols including the scheduled and/or unscheduled symbols. And
      whether the threshold indication of the maxUplinkDutyCyle includes both scheduled and unscheduled signal dutyCycle; and
   making one or more unscheduled transmissions using the adjusted uplink duty cycle and adjusted P-MPR setting.
12. The method of any of the previous embodiments, further comprising:
   obtaining user data; and
   forwarding the user data to a host or a user equipment.

### Group C Embodiments

13. A user equipment for improving power usage, comprising:
   processing circuitry configured to perform any of the steps of any of the Group A embodiments; and
   power supply circuitry configured to supply power to the processing circuitry.
14. A network node for improved power usage, the network node comprising:
   processing circuitry configured to perform any of the steps of any of the Group B embodiments;
   power supply circuitry configured to supply power to the processing circuitry.
15. A user equipment (UE) for improved power usage, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
16. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
17. The host of the previous embodiment, wherein the cellular network further includes a network node configured to communicate with the UE to transmit the user data to the UE from the host.
18. The host of either of the previous 2 embodiments, wherein:
   the processing circuitry of the host is configured to execute a host application, thereby providing the user data; and
   the host application is configured to interact with a client application executing on the UE, the client application being associated with the host application.
19. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
20. The method of the previous embodiment, further comprising:
   at the host, executing a host application associated with a client application executing on the UE to receive the user data from the UE.
21. The method of the previous embodiment, further comprising:
   at the host, transmitting input data to the client application executing on the UE, the input data being provided by executing the host application,
   wherein the user data is provided by the client application in response to the input data from the host application.
22. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
23. The host of the previous embodiment, wherein the cellular network further includes a network node configured to communicate with the UE to transmit the user data from the UE to the host.
24. The host of either of the previous 2 embodiments, wherein:
   the processing circuitry of the host is configured to execute a host application, thereby providing the user data; and
   the host application is configured to interact with a client application executing on the UE, the client application being associated with the host application.
25. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
26. The method of the previous embodiment, further comprising:
   at the host, executing a host application associated with a client application executing on the UE to receive the user data from the UE.
27. The method of the previous embodiment, further comprising:
   at the host, transmitting input data to the client application executing on the UE, the input data being provided by executing the host application,
   wherein the user data is provided by the client application in response to the input data from the host application.
28. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
29. The host of the previous embodiment, wherein:
   the processing circuitry of the host is configured to execute a host application that provides the user data; and
   the UE comprises processing circuitry configured to execute a client application associated with the host application to receive the transmission of user data from the host.
30. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
31. The method of the previous embodiment, further comprising, at the network node, transmitting the user data provided by the host for the UE.
32. The method of either of the previous 2 embodiments, wherein the user data is provided at the host by executing a host application that interacts with a client application executing on the UE, the client application being associated with the host application.
33. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
34. The communication system of the previous embodiment, further comprising:
   the network node; and/or
   the user equipment.
35. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
36. The host of the previous 2 embodiments, wherein:
   the processing circuitry of the host is configured to execute a host application, thereby providing the user data; and
   the host application is configured to interact with a client application executing on the UE, the client application being associated with the host application.
37. The host of the any of the previous 2 embodiments, wherein the initiating receipt of the user data comprises requesting the user data.
38. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
39. The method of the previous embodiment, further comprising at the network node, transmitting the received user data to the host.

ABBREVIATIONS
At least some of the following abbreviations may be used in this
disclosure. If there is an inconsistency between abbreviations,
preference should be given to how it is used above. If listed
multiple times below, the first listing should be preferred
over any subsequent listing(s).

| | |
|---|---|
| BWP | Bandwidth Part |
| CBRA | Contention Based Random Access |
| CE | Coverage Extension |
| CFRA | Contention Free Random Access |
| CP | Cyclic Prefix |
| CSI | Channel State Information |
| DL | Downlink |
| DMRS | Demodulation Reference Signal |
| FDM | Frequency-Division Multiplexing |
| FFT | Fast Fourier Transform |
| gNB | Base station in NR |
| LTE | Long-Term Evolution |
| MAC | Medium Access Control |
| NB-IoT | Narrowband IoT |
| NUL | Normal Uplink |
| PDSCH | Physical Downlink Shared Channel |
| PBCH | Physical Broadcast Channel |
| PRACH | physical random access channel |
| PUSCH | Physical Uplink Shared Channel |
| BWP | Bandwidth Part |
| CBRA | Contention Based Random Access |
| CE | Coverage Extension |
| CFRA | Contention Free Random Access |
| CP | Cyclic Prefix |
| CSI | Channel State Information |
| DL | Downlink |
| DMRS | Demodulation Reference Signal |
| FDM | Frequency-Division Multiplexing |
| FFT | Fast Fourier Transform |
| LTE | Long-Term Evolution |
| MAC | Medium Access Control |
| NB-IoT | Narrowband IoT |
| NUL | Normal Uplink |
| PDSCH | Physical Downlink Shared Channel |
| PBCH | Physical Broadcast Channel |
| PRACH | Physical Random Access Channel |
| PUSCH | Physical Uplink Shared Channel |
| QCL | Quasi-Colocated |
| RAR | Random Access Response |
| RSRP | Reference Signal Received Power |
| RO | PRACH occasion or PRACH transmission occasion |
| RAPID | random access preamble identity |
| RNTI | Radio Network Temporary Identifier |
| SI | System Information |
| SIB | System Information Block |
| SSB | Synchronization Signal Beam |
| SUL | Supplementary Uplink |
| TA | Timing Advance |
| TDM | Time-Division Multiplexing |
| TPC | Transmit power control |
| UL | Uplink |

1. A method of a user equipment, UE, for performing an uplink, UL, transmission, the method comprising:
determining an uplink, UL, duty cycle of the UL transmission including an unscheduled transmission;
applying a power backoff setting to a transmission power for the UL transmission in response to the UL duty cycle being larger than capability information reported by the UE for compliance with electromagnetic power density exposure requirements, to determine an actual transmission power for performing the UL transmission; and
transmitting the UL transmission using the actual transmission power.

2. The method of claim 1, wherein the unscheduled transmission includes a physical random access channel, PRACH, transmission.

3. The method of claim 1, wherein the capability information indicates a maximum percentage of symbols during Is that can be scheduled for the UL transmission at a maximum UE transmission power.

4. The method of claim 1, wherein the power backoff setting comprises a power management maximum power reduction, P-MPR.

5. The method of claim 1, wherein the actual transmission power for performing the UL transmission is a reduced power from the transmission power for the UL transmission.

6. The method of claim 1, wherein the transmission power is one of a maximum UE transmission power or a transmission power estimated by the UE.

7. (canceled)

8. A method of a network node for scheduling an uplink, UL, transmission, the method comprising:
receiving capability information reported by a user equipment, UE;
scheduling the UL transmission according to the reported capability information; and
receiving, from the UE, the UL transmission transmitted using an actual transmission power for performing the UL transmission;
wherein the actual transmission power is obtained by applying a power backoff setting to a transmission power for the UL transmission in response to an UL duty cycle of the UL transmission including an unscheduled transmission being larger than the capability information.

9. The method of claim 8, wherein the unscheduled transmission includes a physical random access channel, PRACH, transmission.

10. The method of claim 8, wherein the capability information indicates a maximum percentage of symbols during Is that can be scheduled for the UL transmission at a maximum UE transmission power.

11. The method of claim 8, wherein the power backoff setting comprises a power management maximum power reduction, P-MPR.

12. The method of claim 8, wherein the actual transmission power for performing the UL transmission is a reduced power from the transmission power for the UL transmission.

13. The method of claim 8, wherein the transmission power is one of a maximum UE transmission power or a transmission power estimated by the UE.

14. (canceled)

15. A user equipment, UE, for performing an uplink, UL, transmission, the UE comprising:
an antenna configured to send and receive wireless signals;
a processing circuitry being configured to perform:
determine an uplink, UL, duty cycle of the UL transmission including an unscheduled transmission;
apply a power backoff setting to a transmission power for the UL transmission in response to the UL duty cycle being larger than capability information reported by the UE for compliance with electromagnetic power density exposure requirements, to determine an actual transmission power for performing the UL transmission; and
transmit the UL transmission using the actual transmission power.

16. The UE of claim 15, wherein the unscheduled transmission includes a physical random access channel, PRACH, transmission.

17. The UE of claim 15, wherein the capability information indicates a maximum percentage of symbols during Is that can be scheduled for the UL transmission at a maximum UE transmission power.

18. The UE of claim 15, wherein the power backoff setting comprises a power management maximum power reduction, P-MPR.

19-21. (canceled)

22. A network node for scheduling an uplink, UL, transmission, the network node comprising:
an antenna configured to send and receive wireless signals;
a processing circuitry being configured to perform:
receive capability information reported by a user equipment, UE;
schedule the UL transmission according to the reported capability information; and
receive, from the UE, the UL transmission transmitted using an actual transmission power for performing the UL transmission;
wherein the actual transmission power is obtained by applying a power backoff setting to a transmission power for the UL transmission in response to an UL duty cycle of the UL transmission including an unscheduled transmission being larger than capability information.

23. The network node of claim 22, wherein the unscheduled transmission includes a physical random access channel, PRACH, transmission.

24. The network node of claim 22, wherein the capability information indicates a maximum percentage of symbols during Is that can be scheduled for the UL transmission at a maximum UE transmission power.

25. The network node of claim 22, wherein the power backoff setting comprises a power management maximum power reduction, P-MPR.

26-28. (canceled)
